(19) United States
(12) Patent Application Publication
(10) Pub. No.: US 2021/0197945 A1
(43) Pub. Date: Jul. 1, 2021

(54) REACTOR

(71) Applicant: SKF MARINE GMBH, Hamburg (DE)

(72) Inventors: Svenja Bierbaum, Hamburg (DE); Joerg Grube, Escheburg (DE); Wiebke Matthias, Hamburg (DE); Pascal Philippsen, Hamburg (DE); Andreas Thiele, Hamburg (DE); Juergen Wetzel, Hamburg (DE)

(21) Appl. No.: 17/269,792

(22) PCT Filed: Aug. 8, 2019
(86) PCT No.: PCT/EP2019/071354

§ 371 Date: Feb. 19, 2021

(30) Foreign Application Priority Data
Aug. 31, 2018 (DE) 10 2018 214 863.5

(51) Int. Cl. B63J 4/00; C02F 1/32

(52) U.S. Cl. CPC B63J 4/002; C02F 2103/008; C02F 1/325

(57) ABSTRACT

A reactor configured to clean ballast water on ships includes a reactor housing having an inlet and an outlet and a reactor tube in the reactor housing providing a fluid connection between the inlet and the outlet. The reactor tube includes an inner wall having a plurality of rounded recesses extending longitudinally from a first end of the reactor tube to a second end of the reactor tube, and the rounded recesses each have a substantially constant cross section from the first end of the reactor tube to the second end of the reactor tube. A radially inwardly projecting ridge extends between each circumferentially adjacent pair of the rounded recesses.

The present invention relates to a reactor for the cleaning of liquids, in particular of ballast water on ships, according to the preamble of patent claim 1.

For improved stabilization, ships regularly take in ballast water and release it again as necessary. The ballast water is directly removed from the body of water, filtered, freed of microbes, microorganisms, and the like or disinfected according to statutory provisions, and subsequently stored in a ballast water tank. The disinfecting is usually effected in a reactor by a treatment with ultraviolet radiation (UV radiation) and/or with ultrasound waves (US waves). During return of the ballast water into the body of water, the ballast water is guided through the reactor again and disinfected again. However, a filtering is not necessarily provided then.

Known reactors for the cleaning of ballast water have a reactor housing that includes a liquid inlet and a liquid outlet. A reactor tube is disposed in the reactor housing that produces a fluid connection between the liquid inlet and the liquid outlet. The reactor housing has a cylindrical inner wall and is penetrated axially by a variety of elongated treatment devices such as UV lamps. In addition, at least one US rod sonotrode is usually provided that extends into the reactor tube.

It is the object of the invention to provide a reactor with an improved cleaning effect.

This object is achieved by a reactor having the features of patent claim 1.

An inventive reactor for the cleaning of liquids, in particular of ballast water on ships, has a reactor housing that includes a liquid inlet and a liquid outlet. In the reactor housing a reactor tube is disposed that produces a fluid connection between the liquid inlet and the liquid outlet. According to the invention the reactor has at least one recess on its inner wall for sectional receiving of a treatment device. The recess has an elongated or groove- or channel-type design and extends over the entire length of the reactor tube. An exemplary treatment device is an elongated lamp that emits ultraviolet radiation (UV). Due to the arrangement of a treatment device in the at least one inner-wall-side recess, the cleaning effect improves compared to a conventional reactor including a reactor tube having a cylindrical inner wall.

The at least one recess is preferably rounded. It is configured as a concave hollowing-out of the inner wall. Due to this measure, unfavorable flow conditions through the recesses are prevented. In addition, it is thereby achieved that the recess-side inner-wall-section surface is guided around the treatment device at a constant spacing, which further improves the cleaning effect since the recess-side inner-wall-section surface has the same spacing from the treatment device over its entire circumferential and axial extension.

Furthermore, the cleaning effect can be improved by a variety of recesses being provided, each for receiving a treatment device. A variety of, for example, UV lamps can thereby be disposed in the reactor so that the UV treatment is effected over the entire flow cross-section of the reactor tube.

For homogenization of the treatment it is preferred when the recesses are uniformly distributed over the inner wall in the circumferential direction.

If in the circumferential direction of the reactor tube the sum of the inner-wall-section surfaces between the recesses is smaller than the sum of the recess-side inner-wall-section surfaces, shadow spaces or shadowing can be prevented, whereby the cleaning effect is further improved.

The reactor housing can have end-side receptacles for receiving the treatment devices, wherein some of the receptacles are disposed in a ring and at least one of the recesses is positioned in the center between the annularly disposed receptacles. A further treatment device can be introduced into the central recess so that the number of the first treatment device such as UV lamps can be further increased, or a different type of treatment device, for example, an ultrasound rod sonotrode (US sonotrode) can be introduced into the reactor tube so that a second treatment method can be carried out for the disinfecting. Since the receptacle is centrally disposed, it is ensured that the treatment of the ballast water is effected over the entire flow cross-section of the reactor tube.

In order to check an effect of the treatment or for adjusting of the treatment devices, for example, with respect to their radiation power/dose/intensity or their number to be activated, it can be advantageous to record a measured value in the ballast water in the reactor tube. For example, the sensor can be configured to determine the permeability of UV radiation or the spread of sound waves due to a US bombardment. In order not to impede the treatment, it is preferred when a sensor provided for this purpose is radially insertable into the reactor space.

A preferred reactor has a variety of treatment devices that are adapted to the respective recess such that they are received in the recess with more than 50% of their cross-sectional surface. The treatment devices are thereby each extensively disposed in the respective recess, which further improves the cleaning effect.

Other advantageous exemplary embodiments of the invention are the subject matter of further dependent claims.

In the following, a preferred starting example of the invention is explained in more detail with reference to schematic illustrations.

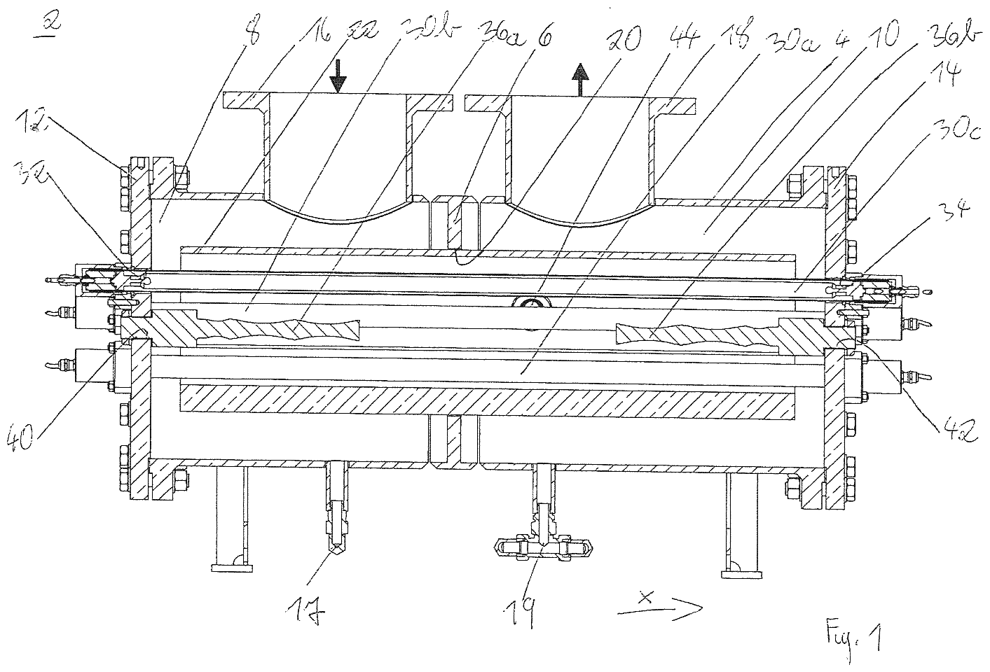

FIG. 1 shows a longitudinal section through an inventive reactor, and

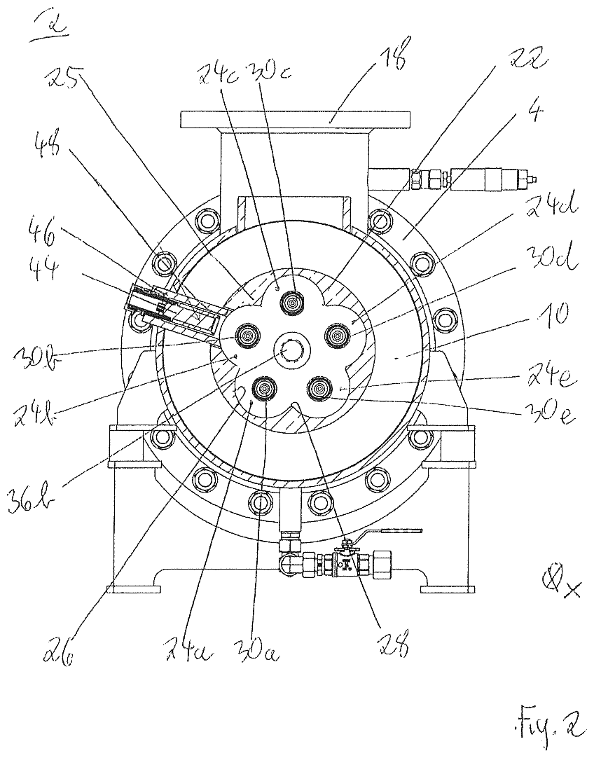

FIG. 2 shows a cross-section through the inventive reactor in the region of a sensor opening.

FIG. 1 shows a longitudinal section through an inventive reactor 2 for the cleaning of a liquid. The reactor 2 is installed, for example, on board a ship and serves for the disinfecting treatment of seawater when it is used as ballast water. Before the seawater is guided into a not-shown ballast tank, it is guided through the reactor 2 and thus subjected to the treatment. Depending on national or international provisions, the ballast water is also supplied to the reactor 2 for repeated treatment before the return from the ballast-water tank into the body of water.

Before the introducing of the ballast water into the reactor housing 2, it is filtered in a not-shown filter, for example, having a mesh width of 20 μm. Contaminants and microorganisms ≥20 μm are thereby removed. The filtering is effected during receiving of the ballast water, but not necessarily during removal of the ballast water from a ballast-water tank. The filter device operates continuously.

According to FIGS. 1 and 2, the reactor 2 has a cylindrical reactor housing 4. The reactor housing 4 includes two inner spaces 8, 10 separated from each other by a separating wall 6, which inner spaces 8, 10 are each closed in a fluid-tight manner, on the side lying away from the separating wall 6, by a cover 12, 14. The inner spaces 8, 10 are each open via upper radial pipe sockets 16, 18, wherein the one pipe socket 16 serves as a liquid inlet, and the other pipe socket 18 as a liquid outlet. For emptying the inner spaces 8, 10, for example, for cleaning, a lower activatable and deactivatable emptying device 17, 19 is respectively provided. The inner spaces 8, 10 have the same inner diameter, but preferably different axial lengths. In the exemplary embodiment shown here the outlet-side inner space 10 has a greater axial extension than the inlet-side inner space 8. A reactor tube 22 that produces a fluid connection between the two inner spaces 8, 10 is guided in a fluid-tight manner through a central opening 20 in the separating wall 6. The opening 20 is centrally disposed in the separating wall 6 so that the reactor tube 22 is centrally positioned in the inner spaces 8, 10.

The inner spaces 8, 10 preferably each have a flow cross-section that is substantially larger, for example, approximately twice as large, as the flow cross-section of the reactor tube 22. A slowdown of the liquid to be treated in the inner spaces 8, 10 thereby occurs. The inlet 16 and the outlet 18 preferably have a uniform flow cross-section that is the same as or nearly equal to the flow cross-section of the reactor tube 22.

The reactor tube 22 is open on its two end sides over its entire flow cross-section. The ballast water thus enters axially into the reactor tube 22, flows through it axially and exits axially from the reactor tube 22. The reactor tube 22 is closed on the circumference. This has the advantage that the ballast water exclusively flows axially along the treatment device. The ballast water only experiences a redirecting in the opening region and escape region of the reactor tube 22 and impacts perpendicularly against the treatment device. The reactor tube 22 has an inner wall that is provided with a variety of elongated recesses 24a to 24e uniformly distributed over the circumference (FIG. 2). The recesses 24a to 24e extend over the entire reactor length and each form, as seen from the reactor tube longitudinal axis x outward, radially outwardly arched recess-side inner-wall-section surface 26. Starting from a cylindrical or nearly cylindrical inner wall, the recesses 24a to 24e are quasi-rounded cavities, each having a constant cross-section over their entire length. The recesses 24a to 24e are thus formed between radially inwardly projecting axial elevations 25. The recess-side inner-wall-section surfaces 26 each merge into each other via a radially inner inner-wall-section surface 28. Viewed in the circumferential direction of the reactor tube 22, the sum of the recess-side inner-wall-section surfaces 26 is substantially larger than the sum of the inner-wall-section surfaces 28 lying between the recesses 24a to 24e. The recesses 24a to 24e serve for receiving a treatment device 30a to 30e, for example, a UV lamp for irradiating with ultraviolet radiation the ballast water flowing through the reactor tube 22.

The UV lamps continuously emit UV light within a preferred wavelength range of 200 nm to 400 nm at various intensities. Since different microorganisms absorb different wavelengths, this range makes it possible to account for and to deactivate a variety of microorganisms.

The treatment devices 30a to 30e extend over the entire length of the reactor tube 22 and emerge from the covers 12, 14 at the ends in a fluid-tight manner through corresponding openings 32, 34. They are each radially rejected from the recess-side inner-circumferential-section surfaces 26. Here their positioning in the recesses 24a to 24e is such that the recess-side inner-circumferential-section surfaces 26 are guided around the respective treatment device 30a to 30e at a constant spacing (FIG. 1). Here the treatment devices 30a to 30e preferably immerse by more than 50% of their cross-sectional surface into the respective recess 24a to 24e.

Further treatment devices 36a, 36b are disposed centrally along the reactor tube longitudinal axis x between the treatment devices 30a to 30e (FIG. 1). The further treatment devices 36a, 36b here are exemplary ultrasound rod sonotrodes (US sonotrodes). They are each guided in a fluid-tight manner through a cover-side central receptacle 40, 42 located in the center of the annularly disposed receptacles 32, 34 and disposed opposite each other. They are spaced from each other in the longitudinal direction of the reactor tube 22. The further treatment devices 36a, 36b preferably each extend over 30% of the axial length of the reactor tube 22.

The treatment with ultrasound causes high-pressure phases (compression) and low-pressure phases (rarefaction). Vapor-filled microbubbles, so-called cavities, in the liquid expand in the low-pressure phase and are compressed in the high-pressure phase, which ultimately causes a destruction of the microbubbles within milliseconds. A large amount of energy is thereby released, which in turn allows local high temperatures and pressure waves to arise. The high temperatures effect, for example, a denaturing of the enzymes and proteins. The pressure waves cause, for example, damage to the zooplankton. The ultrasound bombardment is effected continuously. A preferred frequency spectrum falls in the range wherein physical/mechanical effects of the ultrasound bombardment overlap. This is in the low-frequency range wherein cavity formation is more pronounced than in the high-frequency range at approximately 500 kHz. A low-frequency range falls, for example, around 20 kHz. Large bubbles, large pressure pulses, and high temperatures arise during collapsing of the bubbles. Physical/mechanical effects thus dominate that have a destructive effect on particles and microorganisms. The effect of the US treatment also depends on the ultrasound dose, which can be varied.

Due to the combination of the UV treatment and the US treatment, the disinfecting effect on the microorganisms is increased. The risk of the reactivating of the microorganisms is thereby significantly reduced or even avoided. A combined treatment is also more effective than an individual treatment only with ultraviolet radiation or with ultrasound waves.

For recording a measured value in the liquid, a sensor 44 is provided that is disposed in a sensor tube 46. The sensor tube 46 extends radially with respect to the reactor tube longitudinal axis X and penetrates in a fluid-tight manner an unnumbered radial opening in the reactor housing 4 as well as a radial opening 48 in the reactor tube 22, wherein it terminates flush with a recess-side inner-circumferential section surface 26. Here the sensor 44 is, for example, a UV sensor, using which a permeability of the ballast water for the UV radiation is measured. The permeability can serve for adjusting and controlling the treatment devices 30a to 30e, 36a, 36b. The measurement range of the sensor 44 is adapted to the UV lamps. Its measurement range is preferably 0 to 1000 W/m². Viewed in the flow direction, the sensor 44 is preferably located behind the separating wall 6. It is thus disposed behind the reactor tube center, so that the sensor tube 46 extends through the rear inner space 10.

It should be noted that in principle there is also the possibility to carry out a treatment of the ballast water directly in the inner spaces 8, 10. In the inlet-side inner space 8, a pretreatment could thus be effected, and a post-treatment could be effected in the outlet-side inner space 10. The “core treatment” would then be effected in the reactor tube 22. For this purpose corresponding treatment devices, for example, US sonotrodes 36a, 36a could be used in corresponding receptacles of the cover 12, 14. In particular, different types of treatment, for example, UV treatment or US treatment, or the same treatment could be effected, but with different power/intensity/dosage. For example, since the outlet-side inner space 10 has a larger axial extension than the inlet-side inner space 8, longer US rod sonotrodes 36a, 36b are used in the outlet-side inner space 10.

Disclosed is a reactor for the cleaning of liquids, in particular of ballast water on ships, including a reactor housing that includes a liquid inlet and a liquid outlet and wherein a reactor tube is disposed that produces a fluid connection between the liquid inlet and the liquid outlet, wherein on its inner wall the reactor tube includes at least one channel- or groove-type axial cavity for sectional receiving of an elongated treatment device that extends over the entire length of the reactor tube.

### REFERENCE NUMBER LIST

2 Reactor
4 Reactor housing
6 Separating wall
8 Inner space
10 Inner space
12 Cover
14 Cover
16 Inlet
18 Emptying device
19 Outlet
20 Emptying device
22 Opening in separating wall
22 Reactor tube
24a to 24e Recess
25 Elevation
26 Recess-side inner-circumferential section surface
28 Inner-circumferential section surface between recesses
30a to 30e Treatment devices
32 UV receptacle
34 UV receptacle
36a, b Treatment devices
40 UV receptacle
42 UV receptacle
44 Sensor
46 Sensor tube
48 Opening in the reactor tube
x Reactor tube longitudinal axis

1-8. (canceled)

9. A reactor configured for cleaning ballast water on ships comprising:
a reactor housing having an inlet and an outlet,
a reactor tube in the reactor housing providing a fluid connection between the inlet and the outlet, the reactor tube including an inner wall having a plurality of rounded recesses extending longitudinally from a first end of the reactor tube to a second end of the reactor tube,
wherein the rounded recesses each have a substantially constant cross section from the first end of the reactor tube to the second end of the reactor tube, and
wherein a radially inwardly projecting ridge extends between each circumferentially adjacent pair of the rounded recesses.

10. The reactor according to claim 9,
including an elongated treatment device located at least partially in each of the plurality of rounded recesses.

11. The reactor according to claim 10,
wherein the rounded recesses are uniformly distributed in the circumferential direction.

12. The reactor according to claim 10,
wherein more than half a surface area of the inner wall is located in the plurality of recesses.

13. The reactor according to claim 10,
wherein a first end of the reactor housing includes a plurality of end-side receptacles each configured to receive an end of one of the plurality of elongated treatment devices.

14. The reactor according to claim 13,
wherein a subset of the plurality of receptacles are arranged in a ring.

15. The reactor according to claim 10,
including a sensor mounted in the reactor tube for recording a measured value.

16. The reactor according to claim 10,
wherein at least fifty percent of each of the plurality of treatment devices is located in a respective one of the plurality of recesses.

17. The reactor according to claim 10,
including a sensor mounted in the reactor tube for recording a measured value,
wherein the rounded recesses are uniformly distributed in the circumferential direction,
wherein more than half a surface area of the inner wall is located in the plurality of recesses,
wherein a first end of the reactor housing includes a plurality of end-side receptacles each configured to receive an end of one of the plurality of elongated treatment devices,
wherein a subset of the plurality of receptacles are arranged in a ring,
wherein at least fifty percent of each of the plurality of treatment devices is located in a respective one of the plurality of recesses, and
wherein the treatment devices comprise ultraviolet lamps.

18. The reactor according to claim 10,
wherein, in cross section, each of the recesses extends radially outwardly from a side of an imaginary regular polygon.

19. The reactor according to claim 18, wherein the polygon is a pentagon.

20. The reactor according to claim 18,
wherein each side of the imaginary polygon intersects one of the plurality of elongated treatment devices.

21. The reactor according to claim 10,
wherein the elongated treatment devices comprise ultraviolet lamps.
